(19) United States
(12) Patent Application Publication
(10) Pub. No.: US 2023/0334193 A1
(43) Pub. Date: Oct. 19, 2023

(54) SELECTING STIMULATION CANDIDATES IN LIQUID DISPOSAL NETWORKS

(71) Applicant: SAUDI ARABIAN OIL COMPANY, Dhahran (SA)

(72) Inventors: Mohammed A. Alhuraifi, Al-Qatif (SA); Muhammad A. Al-Hajri, Dammam (SA)

(73) Assignee: SAUDI ARABIAN OIL COMPANY, Dhahran (SA)

(21) Appl. No.: 17/721,951

(22) Filed: Apr. 15, 2022

(51) Int. Cl. G06F 30/20; E21B 43/27; E21B 47/06; E21B 41/00; G06Q 30/02

(52) U.S. Cl. CPC G06F 30/20; E21B 43/27; E21B 47/06; E21B 41/0057; G06Q 30/0283; G06F 2113/08

(57) ABSTRACT

Methods and systems for selecting stimulation candidates in a liquid disposal network of a plurality of wells are disclosed. The method includes obtaining a base disposal pressure and a base injectivity index for each well. The method further includes developing, using a computer processor, a calibrated disposal simulation model for the liquid disposal network, wherein the calibrated disposal simulation model is based, at least, in part, on the base disposal pressure and the base injectivity index. The method still further includes determining, using the computer processor, a predicted disposal pressure and a predicted injectivity index for each well, using a sensitivity analysis of the calibrated disposal simulation model and ranking, using the computer processor, the plurality of wells based, at least in part, on the predicted disposal pressure and the predicted injectivity index for each well.

### BACKGROUND

In the field of oil and gas, liquid disposal networks are used in drilling, completion, and production operations. Liquid disposal networks are regulated facilities designed to receive and dispose of oil field wastewater generated from oil and gas operations. Commonly, hydrocarbons such as oil and gas pumped out of the reservoirs are not pure enough for distribution. Purifying the hydrocarbons produces wastewater, including saltwater, as a byproduct that must be disposed of properly. Wastewater is considered hazardous because of its high salt content, hydrocarbons, and industrial compounds and can cause pollution and contamination if not disposed of correctly. Liquid disposal networks include but are not limited to wastewater disposal wells including saltwater disposal wells. It is beneficial to pump large amounts of disposal water into subsurface porous formations for reservoir recovery factor improvement, cost advantages, time benefits, and efficient waste management.

Accordingly, there exists a need for optimization of liquid disposal network capability. Disposal water pressure is a key element that significantly impacts the liquid disposal network. Abnormal increases in disposal pressure may limit the reliability of liquid disposal networks and processing capability of Gas Oil Separation Plants. It is desired to reduce disposal pressure required in order to pump larger quantities of disposal liquid effectively. This can be achieved by improving the injectivity of disposal wells through disposal well stimulation operations including acid stimulation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for selecting stimulation candidates in a liquid disposal network of a plurality of wells. The method includes obtaining a base disposal pressure and a base injectivity index for each well, developing, using a computer processor, a calibrated disposal simulation model for the liquid disposal network, wherein the calibrated disposal simulation model is base, at least in part, on the base disposal pressure and the base injectivity index, and determining, using the computer processor, a predicted disposal pressure and a predicted injectivity index for each well, using a sensitivity analysis of the calibrated disposal simulation model. The method further includes ranking, using the computer processor, the plurality of wells based, at least in part, on the predicted disposal pressure and a predicted injectivity index for each well.

In one aspect, embodiments disclosed herein relate to a non-transitory computer readable medium storing instructions executable by a computer processor. The instructions including functionality for receiving a base disposal pressure and a base injectivity index for a plurality of wells, developing a calibrated disposal simulation model for a liquid disposal network, wherein the calibrated disposal simulation model is based, at least in part, on the base disposal pressure and the base injectivity index, and determining a predicted disposal pressure and a predicted injectivity index for each well, using a sensitivity analysis of the calibrated disposal simulation model. The method further includes ranking the plurality of wells based, at least in part, on the predicted disposal pressure and a predicted injectivity index for each well.

In one aspect, embodiments disclosed herein relate to a system for selecting stimulation candidates in a liquid disposal network of a plurality of wells. The system including a surface production facility, a wastewater tank configured to receive liquid from the surface production facility, and a computer processor configured to receive a base disposal pressure and a base injectivity index for each well, develop a calibrated disposal model for the liquid disposal network, wherein the calibrated disposal simulation model is based at least in part, on the base disposal pressure and the base injectivity index, determine a predicted disposal pressure and a predicted injectivity index for each well, using a sensitivity analysis of the calibrated disposal simulation model, and rank the plurality of wells based, at least in part, on the predicted disposal pressure and the predicted injectivity index for each well. The system further includes the plurality of wells and a pumping system configured to pump liquid from the wastewater tank into the plurality of wells.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of the elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows an example liquid disposal network in accordance with one or more embodiments.

FIG. 2 shows a flow diagram in accordance with one or more embodiments.

FIG. 3 shows a flowchart in accordance with one or more embodiments.

FIG. 4 shows a computer system in accordance with one or more embodiments.

### DETAILED DESCRIPTION

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from the second element, and the first element may encompass more than one element and succeed (or precede) the second element in an ordering of elements.

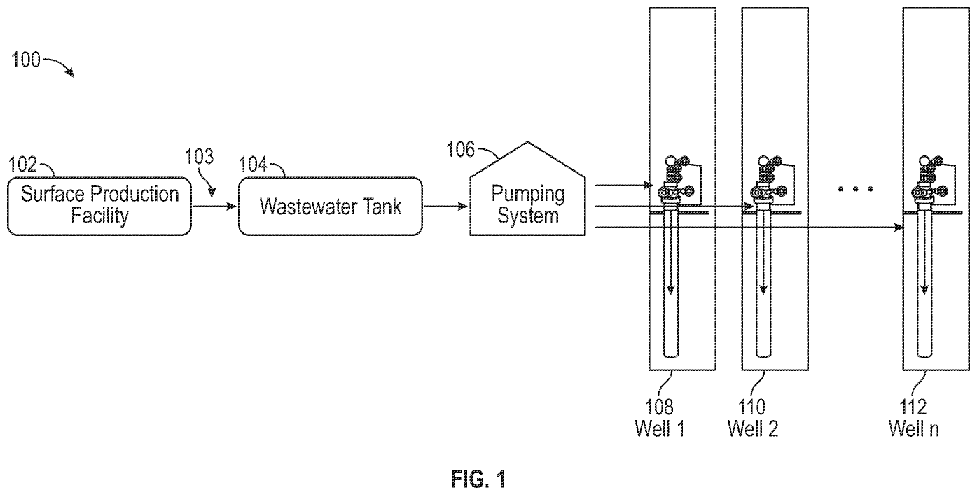

FIG. 1 shows an example liquid disposal network (100) in accordance with one or more embodiments. Specifically, the liquid disposal network (100) in this embodiment is a saltwater disposal network. One of ordinary skill in the art would appreciate the method in this embodiment may be applied on any liquid disposal network (100). The liquid disposal network (100) includes a surface production facility (102), pipelines (103), a wastewater tank (104), a pumping system (106), and at least one disposal well. The surface production facility (102) may be any building or equipment with the capability of producing, treating, or separating produced fluids and gas. The surface production facility (102) may include but is not limited to pumps, pumping units, compressors, generators, gas flares, treaters, separators, and pits. The surface production facility (102) may have the means for testing production capability. Production capability is the ability to maintain the level of production of producing oil wells. The surface production facility (102) may also have the means for transporting and processing oil, gas, and water after separation into marketable products. The surface production facility (102) may also include a truck delivery of produced water and flowback, a tank separator for processed fluid, and storage tanks. The produced water and flowback may come from hydraulic fracturing. The surface production facility (102) may include a pump assembly to filter the fluid if required.

The surface production facility (102) may transfer fluid to the wastewater tank (104) through pipelines (103). Pipelines (103) are a transport of liquid or gas through a system of pipes. The pipelines (103) may be designed for multiple phase flow transportation. The wastewater tank (104) may be any system or container designed to receive and/or treat influent wastewater through physical or chemical methods. The wastewater tank (104) may be referred to as a holding tank. Wastewater may be any fluid after separation considered as “waste” to a person of ordinary skill in the art. An example of wastewater may include saltwater. The wastewater tank (104) may include one or more tanks. The wastewater tank (104) may transfer fluid to a pumping system (106) through pipelines (103). The pumping system (106) may be any system that can house one or more pumps for each well. The pumping system (106) may include but is not limited to injection pumps and transfer pumps. The pumping system (106) may have the ability to pump the fluid from the wastewater tank (104) to the disposal wells through pipelines (103). The disposal wells in this embodiment are represented as well 1 (108), well 2 (110), and well n (112). There may be any number of wells. The pumping system (106) may be capable of pumping to each well individually or to multiple disposal wells simultaneously. The pumping system (106) may be used for pumping fluid directly from the surface production facility (102) to the disposal wells.

The pressure being measured at the output of the pumping system after wastewater tank (104) may be disposal pressure. Disposal pressure may be measured by any tool with the capability of measuring pressure.

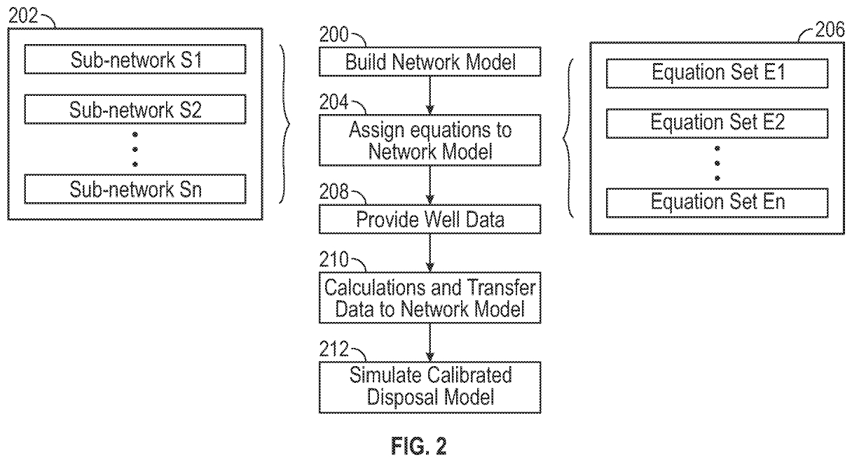

FIG. 2 shows a flow diagram in accordance with one or more embodiments. Specifically, the flow diagram illustrates the process of developing a calibrated disposal simulation model. In one or more embodiments, the calibrated disposal simulation model is based on a flow simulation software that simulates flow in an oil, gas, water, or any mixed production system. The flow simulation software is then calibrated to the liquid disposal network (100) by customizing the simulation software to include or take into account characteristics such as number of pipelines (103), diameter and roughness of the pipelines (103), etc., to develop the calibrated disposal simulation model. The calibrated disposal simulation model models the liquid disposal network (100) and may be designed to predict the behavior of the liquid disposal network (100) for maintenance and modification planning, such as disposal well simulation. The pipelines (103) of the liquid disposal network (100) may operate under steady-state or transient conditions due to the continuous variation in injection or production. Steady-state flow may occur when the boundary conditions of the liquid disposal network (100), such as the pump pressures, are stable over a sufficient duration of time. Transient flow may when the boundary conditions vary rapid, such as when a pump is started or stopped, and result in dynamic flow behavior.

In one or more embodiments, the flow simulation software may include a network model. A network model may be any database model designed to represent objects and the relationship between the objects. The network model may be and is not limited to the Open Systems Interconnection Reference or the Internet model. The network model is used in the flow simulation software to represent the records that have many relationships of the liquid disposal network (100). In Block 200, the network model is built representing a production or injection system for fluid. The network model may use a steady-state approach or a transient state approach. The steady-state approach may include empirical methods or a continuum approach. The empirical approach relies upon experimentation and systematic observation based on measured data. Derived from the measured data, the parameters of the network model are commonly determined, in part, from dimensional analysis. These parameters may include, without limitation, Reynolds Number. In contrast to the empirical approach, the continuum approach may require a mechanistic method including a mechanistic transport equation for each phase within the system. In general, mechanistic method may incorporate significant variables in formulations to provide assessment of uncertainty in predictions of analysis. The procedure of the mechanistic method includes prediction of flow regime, employing mechanistic model, and employment of mechanistic model to predict total pressure gradient. Pressure gradient is a gradient of pressure as a function of position. The flow regime may correspond to the expected or actual operating conditions of the pipeline (103). Mechanistic models may predict liquid holdup and friction factor.

The transient state approach may include a multifluid model, conservation of momentum formulas, pressure equations, energy equations, and interfacial mass transfer. The multifluid model may be any dynamic two-fluid model used for simulation of two-phase flow in pipelines (103). The interfacial mass transfer model may take into account condensation and evaporation. The predictions from the transient approach may be compared to data from literature or laboratory. Either the steady-state approach or the transient state approach may be represented in the network model used in the simulation software. The network model may include but is not limited to various sub-networks (202).

In Block 204, equations are assigned to the sub-networks (202) in the network model. A sub-network (202) may include a piece of equipment in a production system. A flow simulation software may include equations (206). The assigned equations (206) may be formulated to represent the piece of equipment in the sub-network as the condition of which the piece of equipment is in. As an example, the piece of equipment may include a pump.

The equations (206) in the flow simulation software may model multiphase flow from a reservoir to a wellhead or vice versa. In some embodiments, the equations (206) in the flow simulation software may model multiphase flow from the surface production facility (102) to the wellhead of the plurality of disposal wells. The equations (206) may account for flowline and surface facility performance. The surface facility performance may be a comprehensive production system analysis. The equations (206) may be used for performing nodal analysis, gas lift analysis, pressure-volume-temperature (PVT) analysis, erosion analysis, corrosion analysis, production analysis, injection analysis, pipe analysis, etc.

The equations (206) commonly assigned in the empirical method involve prediction of mixture density and friction factor to calculate a holdup function that my adequately fit experimental data for two-phase pressure drop. A pressure drop calculation may include a frictional component such as Dukler frictional pressure drop, a single-phase friction factor, Reynolds number, mixture viscosity, an elevation component, and liquid holdup. Liquid holdup correlation is intended for use in the Dukler friction pressure drop calculation. In two-phase flow such as oil and gas, when gas flows at a greater linear velocity than the liquid, slippage takes place and liquid holdup may occur. Liquid holdup may be essential to the design of flow pipe and analysis of the disposal wells due to its close correlation with the pressure gradient of the pipe. The elevation component of pressure drop may be found using the Flanigan method. Elevation component is used for considering elevation in the pipelines (103).

The equations (206) commonly assigned in the continuum approach involve conservation of mass equations, conservation of momentum equations, pressure equations, mass transfer equations, and energy equations. The conservation of mass equations may include gas phase, liquid film in the wall, and liquid droplets. The conservation of momentum equations may include combined gas/droplets and liquid film. The mass transfer equation for phase transfer may be a function of pressure and temperature. The energy conservation equation may be derived using internal energy per unit mass, enthalpy, elevation, and heat transfer through pipe walls.

In Block 208, well data is provided to the network model. Well data may include but is not limited to pressures, temperatures, flow rates, and injectivity index. The well data inputs may change for the purpose of result estimation. In one or more embodiments, the injectivity index of a disposal well may be changed. The well data may allow for all components to be included in the network model. The components may include but is not limited to pumps, pipelines (103), wells, and other accessories.

Well data and calculations are then transferred to the network model in Block 210. The calibrated model is then simulated in Block 212. Calibrating the simulated model is the process of matching the simulated model to the reality. The calibrated disposal simulation model may include simulating physical phenomena associated with the production or injection system using the network model to provide the results. The simulation may include any number of flow lines and production equipment interconnected at junctions to form a network. The simulation may involve multiphase flow science and use of engineering for large systems of equations. The calibrated disposal simulation model may be used for analysis to identify production bottlenecks and constraints, predict pressure and temperature profiles through flow paths, assess benefits of additions including new wells and pipelines (103), or plan field development.

In some embodiments, the network model may include modules to facilitate generation of a flow simulation. A module may be used to provide a representative for modeling the completions for a well. The well may be vertical, horizontal, fractured, deviated, etc. A module may be used to represent a specific equation type. The equation type may include but is not limited to black-oil equations and equation-of-state equations. A module may be used to represent artificial lift systems such as fluid injection or fluid pumping. The artificial lift systems may include one or more electrical submersible pumps (ESPs).

Various actions of FIG. 2 may be performed by the computer system illustrated in FIG. 4. The method shown in FIG. 2 can be achieved by using any steady-state multiphase flow simulation software.

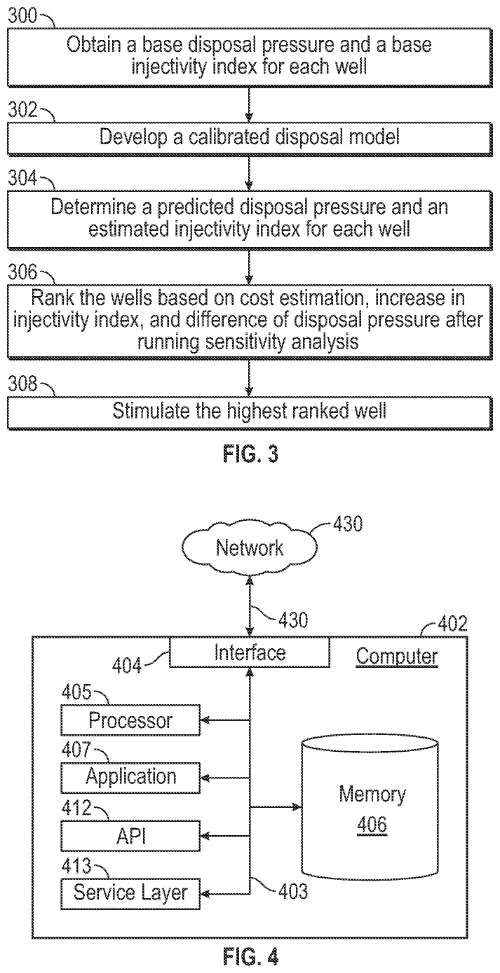

FIG. 3 shows a flowchart in accordance with one or more embodiments. Specifically, the flowchart illustrates a method for selecting the best stimulation candidate in a liquid disposal network (100). Stimulation is a well intervention performed on a well to increase production or injection by improving the flow. Further, one or more blocks in FIG. 3 may be performed by one or more components as described in FIG. 1. While the various blocks in FIG. 3 are presented and described sequentially, one of ordinary skill in the art will appreciate that some or all the blocks may be executed in parallel. Furthermore, the blocks may be performed actively or passively.

In Block 300, a base disposal pressure and a base injectivity index for each disposal well is obtained. The base disposal pressure may be obtained through the pressure gauge (114) measurement as an initial measurement before well stimulation such as acid stimulation. An acid stimulation job may be any treatment of a formation with a stimulation fluid containing a reactive fluid. Injectivity index is the measure of the well fluid take at the base disposal pressure. The base injectivity index may be obtained through pressure transient analysis or by use of steady-state stimulation as an initial record before stimulation. Injectivity index may be defined as rate per delta pressure. In accordance with one or more embodiments, the injectivity index, II, may be defined as:

$$II = ( \frac{Q w}{D P} ) \qquad Equation ( 1 )$$

where Qw is water flow rate and DP is pressure drawdown between reservoir pressure and well sandface pressure. Sandface pressure may be bottomhole pressure.

The base injectivity index may refer to the current injectivity index of each disposal well prior to executing any operation that can change the injectivity index. According to performance curves of the pumping system (106) in liquid disposal networks (100), pumps are more capable of pumping larger quantities of wastewater if the disposal pressure is reduced. As the disposal pressure is reduced the injectivity index may increase. As injectivity index is increased, the flowrate may increase.

In Block 302, a calibrated disposal simulation model may be developed. The calibrated disposal simulation model may be developed using a computer processor. The calibrated disposal simulation model may be any numerical model considered to be reliable and representative of the liquid disposal network (100). The calibrated disposal simulation model is based on a flow simulation software. The calibrated disposal simulation model may be based on the base disposal pressure and the base injectivity index obtained in Block 300. The calibrated disposal simulation model may include a steady-state multiphase flow simulation methodology. The calibrated disposal simulation model may mimic the performance of the liquid disposal network (100) in current conditions and predict the performance of the liquid disposal network (100) under future conditions. In particular, the calibrated disposal simulation model may predict pressure and flowrates at a plurality of locations within the liquid disposal network (100).

The calibrated disposal simulation model may be calibrated by iteratively, recursively, or successively adjusting parameters of a disposal model to match the measured pressures and flowrates at a plurality of locations within the network. The calibrated model may be used for an accurate prediction of disposal pressure when there is a change in the input parameters. For example, the changing input parameters may be the output pressure and/or flowrates of the pumps and/or the injectivity index of the disposal wells.

In Block 304, a predicted disposal pressure and an estimated injectivity index for each disposal well may be determined through sensitivity analysis of the calibrated disposal simulation model. Sensitivity analysis may be run using a computer processor. For example, the sensitivity analysis may quantify the effect of a change in the injectivity index of each disposal well in turn. For example, the injectivity index may change to a higher figure as a result of a stimulation operation such as an acid stimulation job. The sensitivity analysis at different sets may depend on the anticipated improvement of the injectivity indices following acid stimulation jobs. The sensitivity analysis includes a running regression analysis by changing injectivity index of one well at a time to a higher figure for observing the impact on the disposal pressure of the system.

In Block 306, the disposal wells may be ranked on the basis of estimated stimulation costs, increase in injectivity index, and difference of disposal pressures. Ranking the disposal wells may be based on the difference of disposal pressures and the increase in injectivity indices. Ranking the disposal wells may be based on the cost of stimulation estimation. The cost of stimulation estimation may be estimated per well based on analogous historical acid stimulation jobs which were performed on the disposal well itself or any other offset well in the same area. Stimulating a wellbore, for example an acid stimulation, often has a significant cost. The cost may depend upon characteristics of the well. Such characteristics may include, but is not limited to, the depth or ease of access of the well. The increase in injectivity index refers to the estimation of improvement following an acid stimulation job that is based on historical acid stimulation jobs that have been completed on the disposal well itself or any other offset well in the same area. The increase in injectivity index may be the difference between the predicted injectivity index determined in Block 304 and the base injectivity index obtained in Block 300. The difference of disposal pressures may be the difference of the predicted disposal pressure recorded in Block 304 and the base disposal pressure obtained in Block 300.

An advantageous metric for comparison and ranking of a well is a cost normalized difference in injectivity. For example, the cost normalized difference in injectivity may be determined based on the ratio of the predicted difference in injectivity index caused by the stimulation and the estimated cost Similarly, the cost normalized difference in disposal pressures may be determined based on the ratio of the predicted decrease of disposal pressures caused by the stimulation and the estimated cost. Other metrics may be familiar to a person of ordinary skill in the art without departing from the scope of the invention. Ranking the wells may be based on either cost-normalized difference, individually or in combination. Increase in injectivity index is advantageous, whereas reduction of disposal pressure is advantageous. Wells may be assigned an impact value based on their cost normalized differences. It may be advantageous to perform the stimulation on the well or wells with the highest impact values, i.e., those wells that have the highest cost-normalized differences.

In Block 308, the highest ranked well may be stimulated. The highest ranked candidates may be the most promising disposal wells to stimulate as they may result in the most promising investment due to high improvement in disposal flow at the lowest cost. Stimulation may be any type of well intervention including but not limited to acid injection, hydraulic fracturing, and explosives.

FIG. 4 shows a computer (402) system in accordance with one or more embodiments. Specifically, FIG. 4 shows a block diagram of a computer (402) system used to provide computational functionalities associated with described algorithms, methods, functions, processes, flows, and procedures as described in the instant disclosure, according to an implementation. The illustrated computer (402) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device.

Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any, or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402).

The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a non-transitory computer (402) readable medium, or a memory (406), that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A method for selecting stimulation candidates in a liquid disposal network of a plurality of wells, comprising:
obtaining a base disposal pressure and a base injectivity index for each well of the plurality of wells;
developing, using a computer processor, a calibrated disposal simulation model for the liquid disposal network, wherein the calibrated disposal simulation model is based, at least in part, on the base disposal pressure and the base injectivity index of each well;
determining, using the computer processor, a predicted disposal pressure and a predicted injectivity index for each well, using a sensitivity analysis of the calibrated disposal simulation model; and
ranking, using the computer processor, the plurality of wells based, at least in part, on the predicted disposal pressure and the predicted injectivity index for each well.

2. The method of claim 1, further comprising:
stimulating at least one of the plurality of wells based on the ranking of the plurality of wells.

3. The method of claim 1, wherein ranking further comprises:
determining a first difference between the predicted disposal pressure and the base disposal pressure;
determining a second difference between the predicted injectivity index and the base injectivity index; and
ranking the plurality of wells based, at least in part, on the first difference and the second difference.

4. The method of claim 3, wherein ranking further comprises:
for each of the plurality of wells,
determining a cost for stimulation,
determining first cost-normalized difference based on the first difference and the cost, and
determining second cost-normalized difference based on the second difference and the cost; and
ranking the plurality of wells based, at least in part, on the first cost-normalized difference and the second cost-normalized difference.

5. The method of claim 1, wherein the liquid comprises saltwater.

6. The method of claim 1, wherein the stimulation comprises an acid stimulation.

7. The method of claim 1, wherein the calibrated disposal simulation model is based on a steady-state multiphase flow simulation methodology.

8. A non-transitory computer readable medium storing instructions executable by a computer processor, the instructions comprising functionality for:
receiving a base disposal pressure and a base injectivity index for each of a plurality of wells;
developing a calibrated disposal simulation model for a liquid disposal network, wherein the calibrated disposal simulation model is based, at least in part, on the base disposal pressure and the base injectivity index of each well;
determining a predicted disposal pressure and a predicted injectivity index for each well, using a sensitivity analysis of the calibrated disposal simulation model; and
ranking the plurality of wells based, at least in part, on the predicted disposal pressure and the predicted injectivity index for each well.

9. The non-transitory computer readable medium of claim 8, the instructions further comprising functionality for:
determining a first difference between the predicted disposal pressure and the base disposal pressure;
determining a second difference between the predicted injectivity index and the base injectivity index; and
ranking the plurality of wells based, at least in part, on the first difference and the second difference.

10. The non-transitory computer readable medium of claim 9, wherein ranking further comprises:
for each of the plurality of wells,
determining a cost for stimulation,
determining first cost-normalized difference based on the first difference and the cost, and
determining second cost-normalized difference based on the second difference and the cost; and
ranking the plurality of wells based, at least in part, on the first cost-normalized difference and the second cost-normalized difference.

11. The non-transitory computer readable medium of claim 8, wherein the liquid comprises saltwater.

12. The non-transitory computer readable medium of claim 8, wherein the calibrated disposal simulation model is based on a steady-state multiphase flow simulation methodology.

13. A system for selecting stimulation candidates in a liquid disposal network of a plurality of wells comprising:
a surface production facility;
a wastewater tank configured to receive liquid from the surface production facility;
a computer processor configured to:
receive a base disposal pressure and a base injectivity index for each well,
develop a calibrated disposal simulation model for the liquid disposal network, wherein the calibrated disposal simulation model is based at least in part, on the base disposal pressure and the base injectivity index,
determine a predicted disposal pressure and a predicted injectivity index for each well, using a sensitivity analysis of the calibrated disposal simulation model, and
rank the plurality of wells based, at least in part, on the predicted disposal pressure and the predicted injectivity index for each well;
the plurality of wells; and
a pumping system configured to pump liquid from the wastewater tank into the plurality of wells.

14. The system of claim 13, wherein the computer processor is further configured to:
for each of the plurality of wells,
obtain a cost for stimulation,
determine first cost-normalized difference based on the first difference and the cost, and
determine second cost-normalized difference based on the second difference and the cost; and
rank the plurality of wells based, at least in part, on the first cost-normalized difference and the second cost-normalized difference.

15. The system of claim 13, further comprising a stimulation system configured to stimulate at least one of the plurality of wells based, at least in part, on the rank.

16. The system of claim 13, wherein the pumping system comprises of one pump for each well.

17. The system of claim 13, further comprising a pressure gauge configured to measure the base disposal pressure disposed on each well.

18. The system of claim 13, wherein the liquid comprises saltwater.

19. The system of claim 13, wherein the stimulation system comprises an acid stimulation.

20. The system of claim 13, wherein the calibrated disposal simulation model is based on a steady-state multiphase flow simulation methodology.
